(19) United States
(12) Patent Application Publication
(10) Pub. No.: US 2005/0147104 A1
(43) Pub. Date: Jul. 7, 2005

(54) Apparatus and method for multihop MPLS/IP/ATM/frame relay/ethernet pseudo-wire

(76) Inventor: Hamid Ould-Brahim, Kanata (CA)

Correspondence Address: STEUBING AND MCGUINESS & MANARAS LLP, 125 NAGOG PARK, ACTON, MA, 01720, US

(21) Appl. No.: 10/747,967

(22) Filed: Dec. 29, 2003

(51) Int. Cl. H04L 12/28

(52) U.S. Cl. 370/395.5

(57) ABSTRACT

An apparatus for emulating a layer-2 service over at least one network is disclosed. The apparatus includes a signal transmission path. Two provider edge devices are located at opposite ends of the signal transmission path. A provider device is located along the signal transmission path, and this provider device divides the signal transmission path into segments. One of the provider edge devices includes code for adding a demultiplexing header onto data units prior to the data units being transmitted along the signal transmission path.

### FIELD OF THE INVENTION

This invention relates to emulating services over networks and, in particular, multihop MPLS/IP/ATM/frame relay pseudo-wire for emulating services.

### BACKGROUND OF THE INVENTION

The word emulation has special meaning in the fields of computers and telecommunications. Emulation occurs when the function of a device, program, etc. is imitated by modifications to hardware or software that allow the imitating device, system etc. to accept the same data, execute the same programs, and/or achieve the same results as what is being imitated.

Emulation can have significance in the context of geographically spaced apart customer networks. For example, these customer networks could be running native layer-2 services. (A native service is to be contrasted to an emulated service, in that where the native service is being provided, the service is not being imitated.) These customer networks could be connected together by a multi-protocol label switching (MPLS) or internet protocol (IP) network. In this scenario, it may be desirable to emulate the layer-2 services over the MPLS or IP network.

Local area network emulation (LANE) is a known protocol for building emulated services. LANE is used when the backbone is an ATM network, and not where the backbone is an MPLS or IP network. LANE allows legacy networks such as Ethernet, token ring, and fiber distributed data interface (FDDI) to use an ATM network as backbone connections. LANE defines a scheme for encapsulating higher-level protocol datagrams into ATM cells for delivery across the ATM backbone. Since LANE operates in layer-2, it is limited to creating bridge networks (and not routed networks) over the ATM switching fabric.

### SUMMARY OF THE INVENTION

An object of the present invention is to provide a multihop MPLS/IP/ATM/frame/Ethernet relay pseudo-wire.

According to a first aspect of the present invention, there is disclosed an apparatus for emulating a layer-2 service over at least one network. The apparatus includes a signal transmission path. Two provider edge devices are located at opposite ends of the signal transmission path. A provider device is located along the signal transmission path, and this provider device divides the signal transmission path into segments. One of the provider edge devices includes code for adding a demultiplexing header onto data units prior to the data units being transmitted along the signal transmission path.

According to another aspect of the invention, there is disclosed a method for emulating a layer-2 service over at least one network, the method including the steps of:
(1) receiving a data unit at a first provider edge device;
(2) adding a demultiplexing header onto the data unit;
(3) transporting the data unit along a signal transmission path, the signal transmission path being divided into at least two segments by at least one provider device;
(4) receiving a data unit at a second provider edge device;
(5) demultiplexing the data unit; and
(6) transmitting the data unit out of the second provider edge device.

Additionally, there is service emulation over at least one of the at least two segments.

According to yet another aspect of the invention, there is disclosed a network system for emulating a layer-2 service. The network system includes a signal transmission path having two ends. A first provider edge device includes means for adding a demultiplexing header onto data units prior to the data units being transmitted along the signal transmission path. The first provider edge device is located at a first end of the signal transmission path. A second provider edge device is located at the opposite end of the signal transmission path. The network system also includes means for automatically discovering the signal transmission path. A node is located along the signal transmission path, and the node divides the signal transmission path into segments. Local switching occurs at the node.

An advantage of the present invention is that it eliminates end to end signalling between the multihop pseudo-wire provider edge devices. In other words, label distribution protocol downstream unsolicited (LDP-DU) is eliminated.

Another advantage of the present invention is that it eliminates end to end encapsulation negotiation.

Yet another advantage of the present invention is the facilitation of inter-working between BGP/LDP layer-2 VPN signalling protocols. It also facilitates the inter-working of layer-2 tunnelling protocol (L2TP) and MPLS-based pseudo-wire.

Further features and advantages will become apparent from the following detailed description taken in conjunction with the accompanying drawings.

### BRIEF DESCRIPTION OF THE DRAWINGS

FIG. 1 is a diagram illustrating a network reference model with pseudo-wire extending between provider edge devices according to an embodiment of the invention.

FIG. 2 is a diagram similar to FIG. 1 with multihop pseudo-wire instead of non-multihop pseudo-wire extending between the provider edge devices according to an embodiment of the invention.

FIG. 3A is a diagram illustrating three connected pseudo-wire segments according to an embodiment of the invention.

FIG. 3B is a diagram illustrating two connected pseudo-wire segments according to an embodiment of the invention.

FIG. 4 is a diagram illustrating two pseudo-wire segments that share an attachment individual identifier (AII) according to an embodiment of the invention.

FIG. 5 is a diagram illustrating two pseudo-wire segments having their AIIs hairpinned according to an embodiment of the invention.

FIG. 6A is a diagram illustrating a four device virtual private local area network service (VPLS) segment according to an embodiment of the invention.

FIG. 6B is a diagram illustrating a three device VPLS segment according to an embodiment of the invention.

FIG. 7 is a diagram illustrating a VPLS which includes all the devices of FIGS. 6A and FIG. according to an embodiment of the invention.

### DETAILED DESCRIPTION

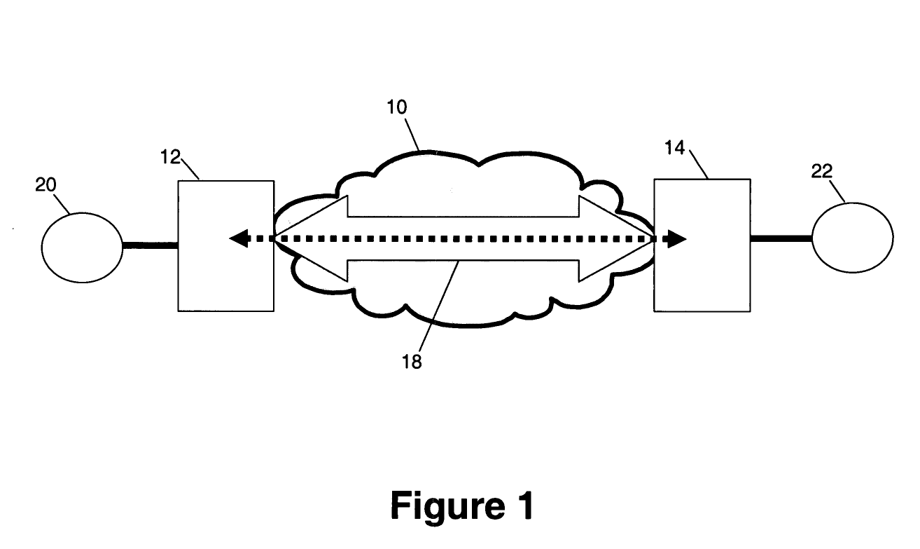

Referring to FIG. 1, there is illustrated an MPLS or IP network 10 extending between provider edge devices 12 and 14. If the network 10 is an MPLS network, the devices 12 and 14 are preferably MPLS enabled routers.

An MPLS network typically includes a label edge router (LER), a label switch path (LSP) and a label switch router (LSR). LERs are routers on the edge of the network that attach labels to packets based on a forwarding equivalence class (FEC), while LSRs are routers capable of forwarding packets according to a label switching algorithm. Thus, the devices 12 and 14 are LERs when the network 10 is an MPLS network. Once packets have been assigned a label by the LER, they are forwarded along the LSP. An LSP is essentially the predetermined route that a set of packets bound to an FEC traverse through an MPLS network to reach their destination. As packets are forwarded along the LSP, each LSR makes forwarding decisions based solely on the contents of the label. At each hop, the LSR strips off the existing label and applies a new label which tells the next hop how to forward the packet.

A packet switched network (PSN) tunnel 18 has been set up within the network 10. If packets being transmitted between the devices 12 and 14 are MPLS packets, the PSN tunnel 18 is a requirement for transmission. The tunnel may not be a requirement for other pseudo-wire embodiments. The tunnel 18 can be an LSP, but it could equally be an IP tunnel, a generic routing encapsulation (GRE) tunnel or a secure internet protocol (IPSec) tunnel. An arbitrary number of pseudo-wires can be carried through a single PSN tunnel.

Layer-2 services (such as frame relay, ATM, Ethernet) can be emulated over an IP/MPLS backbone by encapsulating the layer-2 packet data units (PDUs) and then transmitting them over pseudo-wires. It is also possible to use pseudo-wires to provide SONET circuit emulation over an IP and/or MPLS network.

Reference has been made in this application to layer-2. Layer-2 is sometimes called the link layer. In addition to the link layer, there are other layers including the network layer, the physically layer and the optical layer. The traditional role of layer-2 is switching, while the traditional role of layer-3 is routing.

A possible tunnelling protocol for the tunnel 18 is layer-2 tunnelling protocol version 3 (L2TPv3). L2TPv3 provides a means to interconnect transparently at high speed and at the layer-2 level, a pair of interfaces through a PSN (for instance an IPv4 base network). L2TPv3 can be used to build a multitude of layer-2 based services like VLL, layer-2 provider provisioned virtual private network (PPVPN).

In ATM, a data unit is frequently referred to as an ATM cell. Data units sent over the internet are frequently referred to as packets. For the present purposes, the term packet is to be given a broad meaning where possible. A packet means a data unit at any layer of the OSI protocol stack.

Client edge device 20 (illustrated in FIG. 1) interfaces with the network 10 via the provider edge device 12. Also the client edge device 20 will typically be a part of client network (not illustrated). A packet to be transmitted through the network 10 is first transmitted from the device 20 to the device 12.

Once the packet is received by the provider edge device 12, and before the packet is transmitted on the pseudo-wire, the packet is modified at the provider edge device 12. If the device 12 is a router, the router is called an ingress router. Device 12 puts a pseudo-wire demultiplexor field onto the packet. Where the network 10 is an MPLS network, the pseudo-wire demultiplexor field is an MPLS label. When the packet arrives at the remote end point of the pseudo-wire (i.e. arrives at the provider edge device 14), the demultiplexor is what enables the receiver to identify the particular pseudo-wire on which the packet has arrived.

In order for the packet to travel through the PSN tunnel 18, an additional header needs to be prepended to the packet. If the PSN tunnel is an MPLS LSP, then putting on a PSN tunnel encapsulation is a matter of pushing on an additional MPLS label. Where the PSN tunnel is a GRE tunnel, then putting on the tunnel encapsulation requires prepending an IP header and a GRE header.

A layer-2 PDU will be received at the provider edge device 12, encapsulated at the device 12, transported, decapsulated at provider edge device 14, and transmitted out of the device 14. Where the device 12 is an ingress router, the device 14 is an egress router.

Client edge device 22 interfaces with the network 10 via the provider edge device 14. Also the client edge device 22 will typically be a part of client network (not illustrated). This client network will also typically be located at a different geographical location than the client network associated with the client edge device 20. A packet transmitted out of the provider edge device 14 is received by the client edge device 22 for processing, for example, in a network running a native layer-2 service.

The protocol for assigning and distributing a pseudo-wire label is called label distribution protocol (LDP). An LDP session must be set up between pseudo-wire end points. Where the network 10 is MPLS network, the protocol can also be referred to as MPLS LDP. LDP-DU is where the LSP defines a label value for each known IP destination.

A pseudo-wire can be thought of as connecting two forwarders. Protocol used to set up pseudo-wire must allow the forwarder at one end of the pseudo-wire to identify the forwarder at the other end. Also, when the provider edge device 14 receives a packet over pseudo-wire, it must be able to associate that packet with a particular pseudo-wire.

A feature of pseudo-wires within the network 10 are the various permutations of functionality. A bi-direction pseudo-wire is possible. This type of pseudo-wire consists of a pair of unidirectional LSPs, one in each direction. It is also possible for pseudo-wires to support TDM traffic. In this case, these pseudo-wires must emulate the circuit characteristics of SONET/SDH payloads.

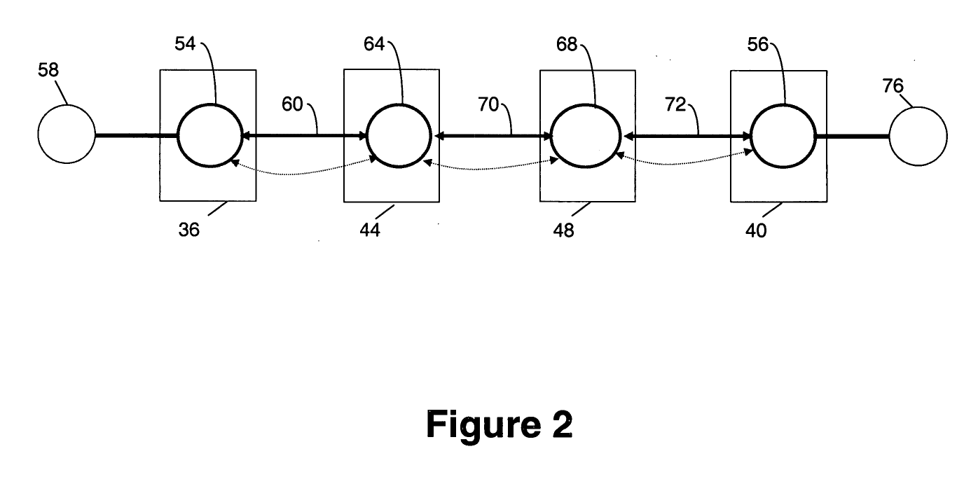

FIG. 2 is a diagram of a multihop pseudo-wire extending between a provider edge device 36 and a provider edge device 40. A multihop pseudo-wire is a pseudo-wire built from a list of pseudo-wire segments. A multihop pseudo-wire path extends between the device 36 and the device 40. Along this path are multihop pseudo-wire nodes 44 and 48.

A multihop pseudo-wire node can be a provider edge device or a provider router as defined in PPVPN. Although only two multihop pseudo-wire nodes are illustrated between the provider edge devices 36 and 40, other embodiments of multihop pseudo-wires could have three or more nodes between the devices 36 and 40. Yet another embodiment of a multihop pseudo-wire has only one node between the devices 36 and 40.

PDUs can be transmitted along the multihop pseudo-wire from the device 36 to the device 40 or alternatively, can be transmitted in the opposite direction. Therefore the device 36 includes both a source and target 54 for PDUs. So too does the device 40 include a source and target 56 for PDUs.

A transmission of a PDU from the device 36 to the device 40 is as follows. First the PDU is received by the provider edge device 36 from client edge device 58. The provider edge device 36 then encapsulates the PDU. Next the PDU is transported along a pseudo-wire segment 60 to pseudo-wire hop 64.

A hop is a concept understood by those skilled in the art of routed networks. Hop can be defined as a jump that a packet takes from one router to the next. A hop can also be defined as a transmission from one network node to another. Finally a hop can be one direct host-to-host connection forming part of the route between two hosts in a routed network.

From the hop 64, the packet proceeds to the next hop 68 along pseudo-wire segment 70. From the hop 68, the PDU is transported along the next pseudo-wire segment 72 to the target 56. At the provider edge device 40, the PDU is decapsulated and transmitted out of the device 40 to client edge device 76.

Native services are being run at portions outside of the mulithop pseudo-wire (e.g. the client edge devices is 58 and 76). Emulated service(s) are being run between the client edge devices 58 and 76. The client edge devices 58 and 76 can be the same client edge devices as the client edge devices 20 and 22 illustrated in FIG. 1. Also the client edge devices 58 and 76 are typically a part of client networks.

An attachment identifier (AI) is an important concept for pseudo-wires. An AI is the identifier of the attachment circuit in which in a case of point to point pseudo-wire is used to identify the forwarders. When used in a VPN context, an AI includes an attachment group identifier (AGI) and an AII. With respect to the meaning of “group” in attachment group identifier, a set of forwarders are members of a particular group. Pseudo-wires may only be set among members of the group.

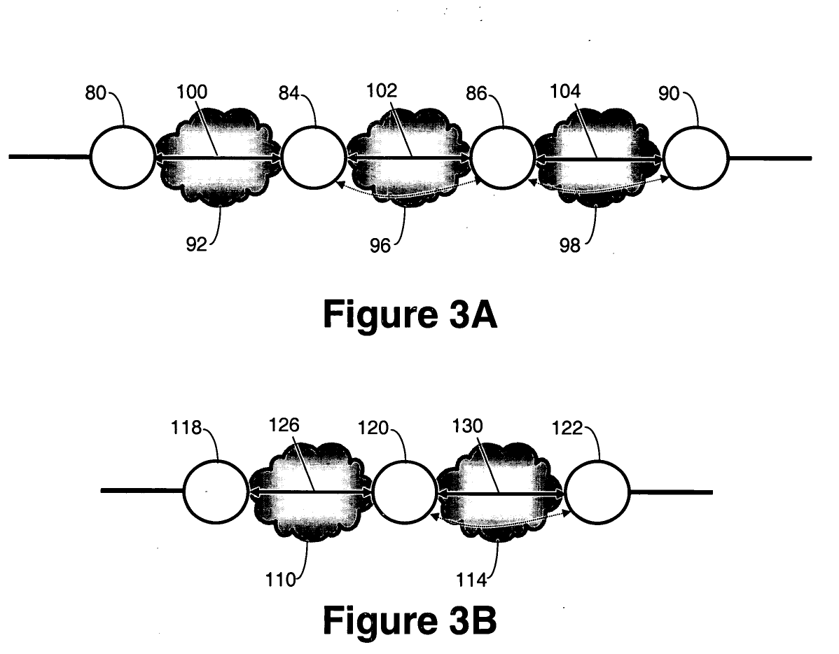

FIG. 3A is a diagram illustrating a multihop pseudo-wire with three pseudo-wire segments. Four identifiers 80, 84, 86 and 90 are associated with four forwarders. If a PDU is transported from left to right, the identifier 80 is source attachment identifier (SAII) and the identifier 90 is a target attachment identifier (TAII). The identifiers 84 and 86 are AIIs. Three different network portions 92, 96 and 98 extend between forwarders. Pseudo-wire segments 100, 102 and 104 are within the network portions 92, 96 and 98 respectively. The pseudo-wire segment 102 can be any layer-2 and/or layer-3 media and transport technology.

FIG. 3B is a diagram illustrating a different multihop pseudo-wire. Network portions 110 and 114 are spaced between identifiers 118, 120 and 122. The identifiers 118, 120 and 122 are an SAII, an AII and a TAII respectively when a PDU is being transported from left to right. Within the network portions 110 and 114 are pseudo-wires 126 and 130 respectively. The network portion 114 can include any layer-2 and/or layer-3 media and transport technology.

In one embodiment for the multihop pseudo-wire, the standards for the network portions 110 and 114 could be AS1 and AS2 respectively.

Applicability Statement 1 (AS1) is a specification for electronic data interchange (EDI) communications between businesses using e-mail protocols. AS1 standard provides secure multi-purpose internet mail extensions (S/MIME) and uses simple mail transfer protocol (SMTP) to transmit data using e-mail.

Applicability Statement 2 (AS2) is a specification for EDI between businesses using hypertext transfer protocol (HTTP). The AS2 standard provides S/MIME and uses HTTP or a more secure version, HTTPS, to transmit data over the internet.

The network portions 110 and 114 can have different signalling. For example, the network portion 110 could use LDP signalling, and the network portion 114 could use border gateway protocol (BGP) signalling.

Although it has not been illustrated in FIG. 3A or 3B, embodiments of multihop pseudo-wires having more than four forwarders are possible. A multihop pseudo-wire having K forwarders will have at least K-2 non-source/target AIIs. Regardless of the embodiment, a multihop pseudo-wire will always have an SAII and a TAII.

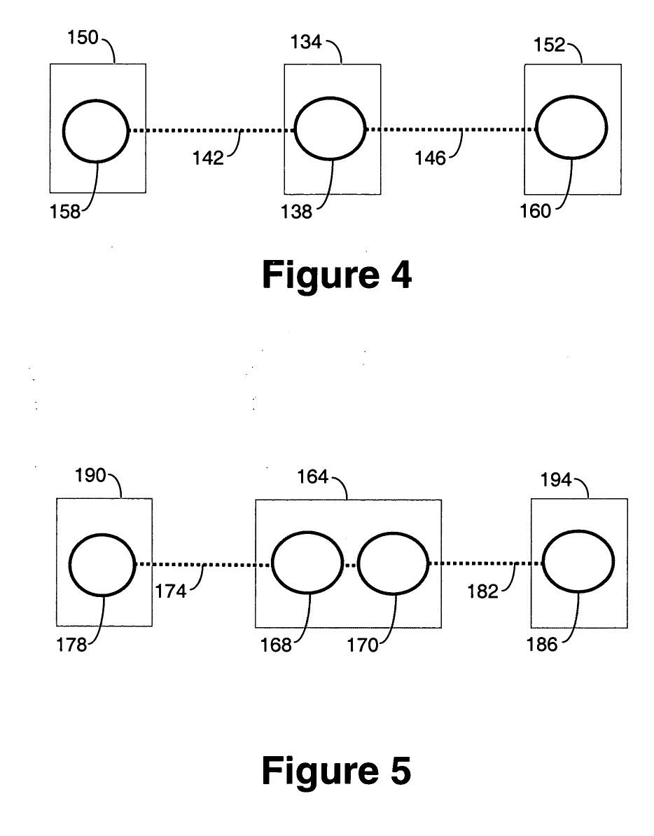

FIG. 4 illustrates a multihop pseudo-wire with multihop pseudo-wire node 134 having a single AII 138. The node 134 connects pseudo-wire segment 142 and pseudo-wire segment 146. The pseudo-wire segment 142 extends between a provider edge device 150 and the node 134. The pseudo-wire segment 146 extends between the node 134 and a provider edge device 152. The devices 150 and 152 have identifiers 158 and 160, which are an SAII and a TAII respectively when PDUs are being transmitted from the device 150 to the device 152. Where the segment 142 is identified as PW1 and the segment 146 is identified as PW2, the multihop pseudo-wire of FIG. 4 can be identified in shorthand as <PW1:<SAII,AII1,AGI>, PW2:<AII,TAII,AGI>>.

It will be appreciated that the AGI for the pseudo-wire 142 will be the same as the AGI for the pseudo-wire 146. AII pseudo-wires in a single virtual private network (VPN) will be associated with a single AGI.

FIG. 5 illustrates a multihop pseudo-wire wherein local switching occurs at multihop pseudo-wire node 164. The node 164 has two AIIs 168 and 170. The AII 168 and the AII 170 are hairpinned.

Hairpin is a concept understood by those skilled in the art. Hairpin connections are those connections that terminate in a gateway but are immediately rerouted over a telephone network. Hairpinning is referred to in the context of a tributary-to-tributary concept associated with public switched telephone networks (PSTNs). Hairpin occurs when an incoming PSTN call is looped back out onto the PSTN. This is done if the call cannot be delivered using IP.

The identifiers for pseudo-wire 174 include SAII 178 and the AII 168. Identifiers for pseudo-wire 182 include the AII 170 and TAII 186. Again the referred to identifiers are with respect to a PDU being transmitted from provider edge device 190 to provider edge device 194 (as supposed to being transmitted in the opposite direction). Where the segment 174 is identified as PW1 and the segment 182 is identified as PW2, the multihop pseudo-wire of FIG. 5 can be identified in shorthand as <PW1:<SAII,AII1,AGI>, PW2:<AII2,TAII,AGI>>.

In the discovery for the multihop pseudo-wire shown in FIG. 5, the multihop pseudo-wire address for the node 164 will be advertised. Consequently, this is one way of identifying local switching at the node 164.

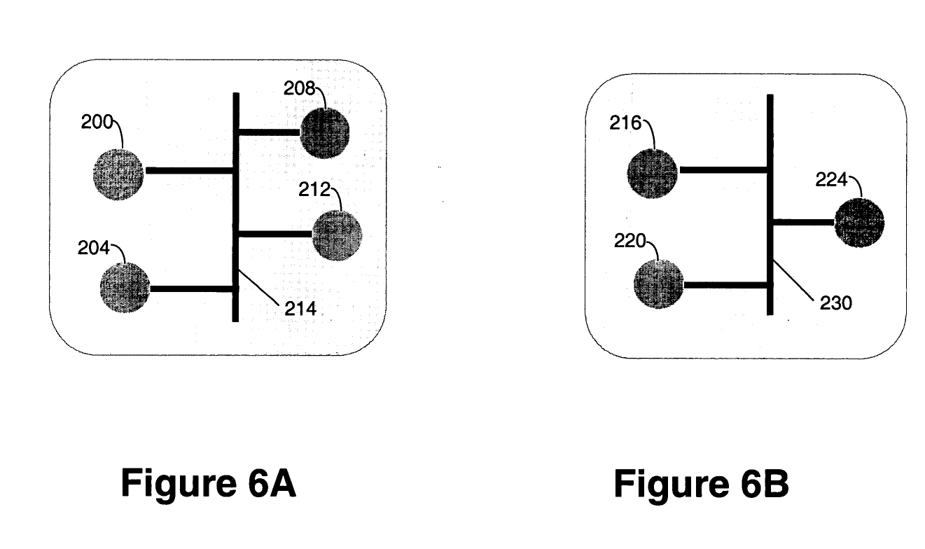

VPLS segments (Ethernet LANS) are illustrated in FIGS. 6A and 6B. VPLS is an internet-based multipoint-to-multipoint layer-2 VPN. With VPLS, multiple Ethernet LAN sites can be connected to each other across an MPLS backbone. To the customer, all sites that are interconnected by VPLS appear to be on the same Ethernet LAN (even though traffic travels across a service provider network).

Referring to FIG. 6A, the illustrated Ethernet LAN has client network devices 200, 204, 208 and 212. These devices can communicate with each other by LAN communication means 214. Similarly in FIG. 6B, the illustrated Ethernet LAN has client devices 216, 220 and 224. These devices can communicate with each other by LAN communication means 230.

Employing a multihop pseudo-wire, these two VPLS segments can be joined together in a VPLS. For example, the client edge device 58 illustrated in FIG. 2 can be a part of the Ethernet LAN of FIG. 6A, and likewise the client edge device 76 can be a part of the Ethernet LAN of FIG. 6B.

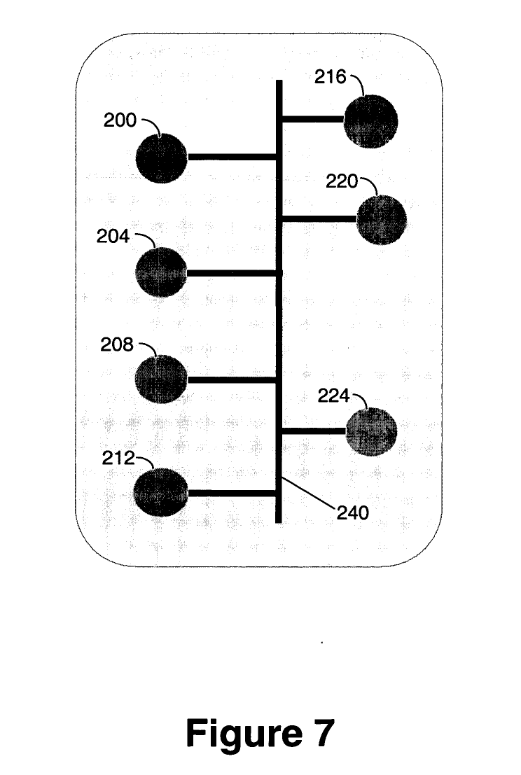

A VPLS which includes the Ethernet LANs of FIGS. 6A and 6B is illustrated in FIG. 7. Thus the devices 216, 220 and 224 appear to be on the same Ethernet LAN as devices 200, 204, 208 and 212 even though the traffic travels across a multihop pseudo-wire. For example, the device 212 can communicate with the device 224 via communication means 240 just as it would communicate with the device 204. The communication means 240 would include a multihop pseudo-wire such as the multihop pseudo-wire illustrated in FIG. 2.

Glossary of Acronyms Used
AGI—Attachment Group Identifier
AI—Attachment Identifier
AII—Attachment Individual Identifier
AS1—Applicability Statement 1
AS2—Applicability Statement 2
BGP—Border Gateway Protocol
EDI—Electronic Data Interchange
FDDI—Fiber Distributed Data Interface
FEC—Forwarding Equivalence Class
GRE—Generic Routing Encapsulation
HTTP—Hypertext Transfer Protocol
IP—Internet Protocol
IPSec—Secure Internet Protocol
L2TP—Layer-2 Tunnelling Protocol
L2TPv3—Layer-2 Tunnelling Protocol Version 3
LANE—Local Area Network Emulation
LDP—Label Distribution Protocol
LDP-DU—Label Distribution Protocol Downstream Unsolicited
LER—Label Edge Router
LSP—Label Switch Path
LSR—Label Switch Router
MPLS—Multi-Protocol Label Switching
PDU—Packet Data Units
PPVPN—Provider Provisioned Virtual Private Network
PSN—Packet Switched Network
PSTN—Public Switched Telephone Network
SAII—Source Attachment Individual Identifier
S/MIME—Secure Multi-Purpose Internet Mail Extensions
SMTP—Simple Mail Transfer Protocol
TAII—Target Individual Attachment Identifier
VPLS—Virtual Private LAN Service
VPN—Virtual Private Network

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. An apparatus for emulating a layer-2 service over at least one network, the apparatus comprising:
a signal transmission path;
two provider edge devices located at opposite ends of said signal transmission path; and
a provider device located along said signal transmission path such that said provider device divides said signal transmission path into segments,
wherein one of said provider edge devices includes code for adding a demultiplexing header onto data units prior to said data units being transmitted along said signal transmission path.

2. An apparatus as claimed in claim 1 wherein said signal transmission path includes at least one of the following: an LSP, an IP tunnel, a GRE tunnel and an IPSec tunnel.

3. An apparatus as claimed in claim 1 wherein said one of said provider edge devices further includes code for encapsulating said data units prior to said data units being transmitted along said signal transmission path.

4. An apparatus as claimed in claim 1 wherein said provider edge devices are directly connected to client edge devices that are devices in geographically separated VPLS segments.

5. An apparatus as claimed in claim 3 wherein signalling associated with one of said segments is LDP signalling, and signalling associated with another of said segments is BGP signalling.

6. An apparatus as claimed in claim 3 wherein one of said segments includes a layer-2 transport technology and another of said segments includes a layer-3 transport technology.

7. An apparatus as claimed in claim 4 wherein said one of said provider edge devices further includes code for adding an MPLS label onto said data units prior to said data units being transmitted along said signal transmission path.

8. A method for emulating a layer-2 service over at least one network, the method comprising the steps of:
receiving a data unit at a first provider edge device;
adding a demultiplexing header onto said data unit;
transporting said data unit along a signal transmission path, said signal transmission path being divided into at least two segments by at least one provider device;
receiving a data unit at a second provider edge device;
demultiplexing said data unit; and
transmitting said data unit out of said second provider edge device,
wherein there is a service emulation over at least one of said at least two segments.

9. A method as claimed in claim 8 wherein said signal transmission path includes at least one of the following: an LSP, an IP tunnel, a GRE tunnel and an IPSec tunnel.

10. A method as claimed in claim 9 further comprising the step of transmitting a data unit out of a local area network before the step of receiving a data unit at a first provider edge device.

11. A method as claimed in claim 10 further comprising the step of receiving a data unit at another local area network.

12. A method as claimed in claim 9 wherein one of said at least two segments is within an MPLS network.

13. A method as claimed in claim 12 wherein said first provider edge device is an ingress router, and said provider device and said first provider edge device are MPLS enabled routers.

14. A method as claimed in claim 13 further comprising the step of adding an MPLS label onto said data unit before the step of transporting said data unit along a signal transmission path.

15. A method as claimed in claim 14 wherein said one of said at least two segments includes a layer-3 transport technology and another of said at least two segments includes a layer-2 transport technology.

16. A network system for emulating a layer-2 service, comprising:
a signal transmission path having two ends;
a first provider edge device including means for adding a demultiplexing header onto data units prior to said data units being transmitted along said signal transmission path, said first provider edge device being located at a first end of said signal transmission path;
a second provider edge device being located at the opposite end of said signal transmission path;
means for automatically discovering said signal transmission path; and
a node located along said signal transmission path such that said node divides said signal transmission path into segments,
wherein local switching occurs at said node.

17. A network system as claimed in claim 16 wherein said node include a hairpin connection.

18. A network system as claimed in claim 17 wherein one of said segments includes a layer-2 transport technology.

19. A network system as claimed in claim 18 wherein said network system connects a first and a second local area network, and said data units are transmitted from said first local area network to said second local area network.

20. A network system as claimed in claim 19 wherein said network system supports at least two of the following: Martini, layer-2 tunnelling protocol and MPLS.
